(19) United States
(12) Patent Application Publication
(10) Pub. No.: US 2021/0233443 A1
(43) Pub. Date: Jul. 29, 2021

(54) DIGITAL SYSTEMS FOR VIRTUAL SETTING IN INTERIOR SPACES

(71) Applicant: Juan Ernesto Souffrain, Cliffside Park, NJ (US)

(72) Inventor: Juan Ernesto Souffrain, Cliffside Park, NJ (US)

(21) Appl. No.: 17/156,615

(22) Filed: Jan. 24, 2021

Related U.S. Application Data
(60) Provisional application No. 62/965,250, filed on Jan. 24, 2020.

(51) Int. Cl. G09F 27/00; G06F 3/14; G06F 3/0482; G06F 3/0484; G06F 3/16; E06B 9/58; E06B 9/68; G09F 9/30

(52) U.S. Cl. CPC G09F 27/008; G06F 3/14; G06F 3/0482; G06F 3/04847; G09F 9/33; E06B 9/58; E06B 9/68; G09F 9/301; G06F 3/162

(57) ABSTRACT

Digital systems for virtual settings in interior spaces include a plurality of digitally interconnected devices which operate to provide an occupant with the sense that they are located in a particular destination. The destination and accessory ambiance may be customized by a user with a variety of pre-loaded data. The primary element of the system is one or more specially designed digital screens that are designed to operate as a retractable blind for a window, wall, or surface, and are useful for providing a live or pre-recorded artificial view on a surface for use in a building, particularly, but not limited to, windows. The retractable blind device includes a flexible digital screen having: a screen with a viewing surface; a blind housing; and a software application. The housing may be configured to receive and conceal the flexible digital screen when retracted.

### CROSS-REFERENCE TO RELATED APPLICATION(S)

The present application is related to and claims priority to U.S. Provisional patent Application No. 62/965,250 filed Jan. 24, 2020, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of interior design of existing art and more specifically relates to a system for implementing a virtual setting for an interior space.

### RELATED ART

Many individuals in modern society live and work in residential and commercial buildings. Often these buildings do not have good views. Real estate may be extremely expensive for those who wish to have buildings located in locales with premium views. Good views are desirable as they may relax the occupants and clients. Moving to a location with good views can be time-consuming even if money is not an object. Accordingly, there is perceived a need for a solution which can offer consumers the above-listed benefits of desirable views, but without the cost and location constraints of attaining those views by physical proximity.

Various attempts have been made to solve problems found in facsimile and static presentation processing art. Among these are found in: U.S. Patent and Publication Nos. U.S. Pat. Nos. 9,467,579; 5,253,051; 2013/0222371; 2017/0094167; U.S. Pat. No. 9,195,320; and 2016/0307545. This prior art is representative of facsimile and static presentation processing.

None of the above inventions and patents, taken either singly or in combination, is seen to describe the invention as claimed. Thus, a need exists for a reliable view window blinds system, and to avoid the above-mentioned problems.

### SUMMARY OF THE INVENTION

The present invention advantageously fills the aforementioned deficiencies by providing a means to transform a conventional window without a pleasant view into a window that appears to have a pleasant view. The present invention is superior to other systems in that it cost-effectively provides a pleasant ambiance for conventional windows not having a favorable view.

Digital systems for virtual settings in interior spaces include a plurality of digitally interconnected devices which operate to provide an occupant with the sense that they are located in a particular destination. The destination and accessory ambiance may be customized by a user with a variety of pre-loaded data. The primary element of the system is one or more specially designed digital screens that are designed to operate as a retractable blind for a window, wall, or surface, and are useful for providing a live or pre-recorded artificial view on a surface for use in a building, particularly, but not limited to, windows. The retractable blind device includes a flexible digital screen having: a screen with a viewing surface; a blind housing; and a software application. The housing may be configured to receive and conceal the flexible digital screen when retracted.

In this way, the system provides building occupants with an option of what they want to see when they look outside of their window. Implementation of this system offers the benefit of desirable views in any interior space in which the retractable blind device can be mounted. Optionally, the system can also be used on ceilings in order to provide a view of a sunny bright sky or a starlit night; or on floors in order to provide a view of a property built on the ocean with see-through floors so that occupants can see ocean life below. The digital customization that the remote control via the software application provides means that the system can be used in a variety of creative ways t enact a virtual setting.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, digital systems for virtual settings in interior spaces, constructed and operative according to the teachings of the present disclosure.

FIG. 1 is a perspective view of the digital systems for virtual settings in interior spaces during an ‘in-use’ condition, according to an embodiment of the disclosure.

FIG. 2 is a perspective view of the window-shade assembly of the digital system for virtual settings in interior spaces of FIG. 1, according to an embodiment of the present disclosure.

FIG. 3 is a partial cutaway view of the window-shade assembly of the digital system for virtual settings in interior spaces of FIG. 1, according to an embodiment of the present disclosure.

FIG. 4 is a diagram of the interconnectivity of the digital system for virtual settings in interior spaces of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a system for implementing a virtual setting for an interior space and more particularly to digital systems for virtual settings in interior spaces as used to improve the ambiance of office spaces or other buildings.

Generally, the digital system for virtual settings comprises a specially designed digital screen that is specially made to fit virtually any window, wall or surface. The window blind or shade of the system may include an electronics frame or header containing video electronics, an optional track adapted to surround the window, a shade connected to the header having a video display screen, and a shade retractor mounted in or to the header having a reversible motor. The shade may be retractable by the motor. The support preferably comprises a track whereby the screen rides in the track and the screen is retractable by the motor. The blind has an extended shade position in which the shade or screen is disposed in the track and the track-shade assembly or the track-screen assembly is adapted to block window light.

An optional speaker system may enable a user to play the music or ambiance. There may also be an optional security camera feature that can record the inside and outside of the building, providing the user with an integrated security system. The user can stream the live security footage to a computing device or access the pre-recorded footage at the touch of a button any time via a website or a mobile software application.

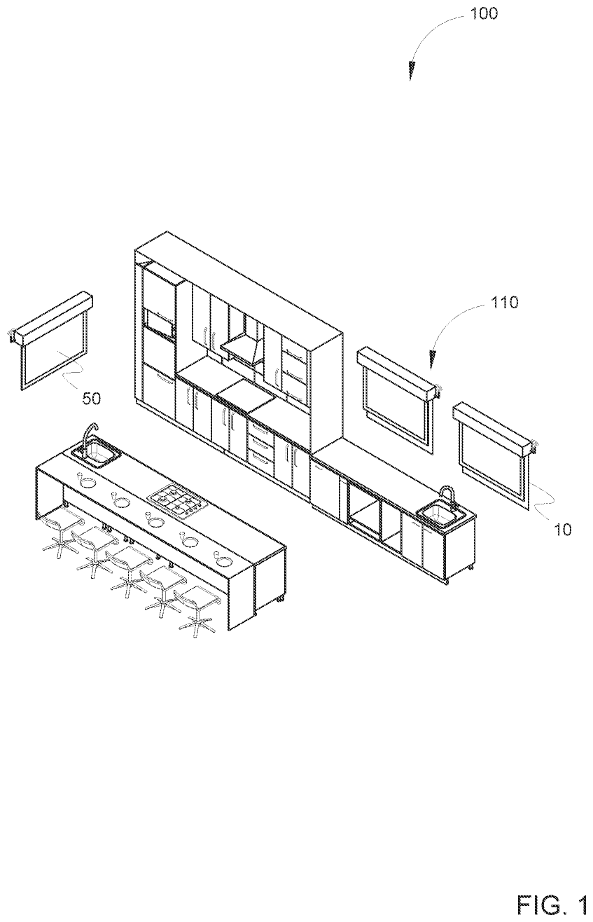

Referring now more specifically to the drawings by numerals of reference, there is shown in FIGS. 1-4, various views of a digital system for virtual settings in interior spaces 100.

FIG. 1 shows a digital system for virtual settings in interior spaces during an ‘in-use’ condition, according to an embodiment of the present disclosure. Here, the digital system for virtual settings in interior spaces may be beneficial for use by a user to implement a virtual setting for an interior space. As illustrated, the digital system for virtual settings in interior spaces 100 may include at least one window-shade assembly 110, which is structured and configured to be placed over an existing window 10. Multiples of at least one window-shade assembly 110 may be positioned over multiple corresponding windows as illustrated. Preferably, system 100 may be configured to display different divisions of the virtual setting on each of the at least one window-shade assemblies 110, such that in combination, the window-shade assemblies 110 appear to be offering a view of an actual scene outside, as though viewed through windows.

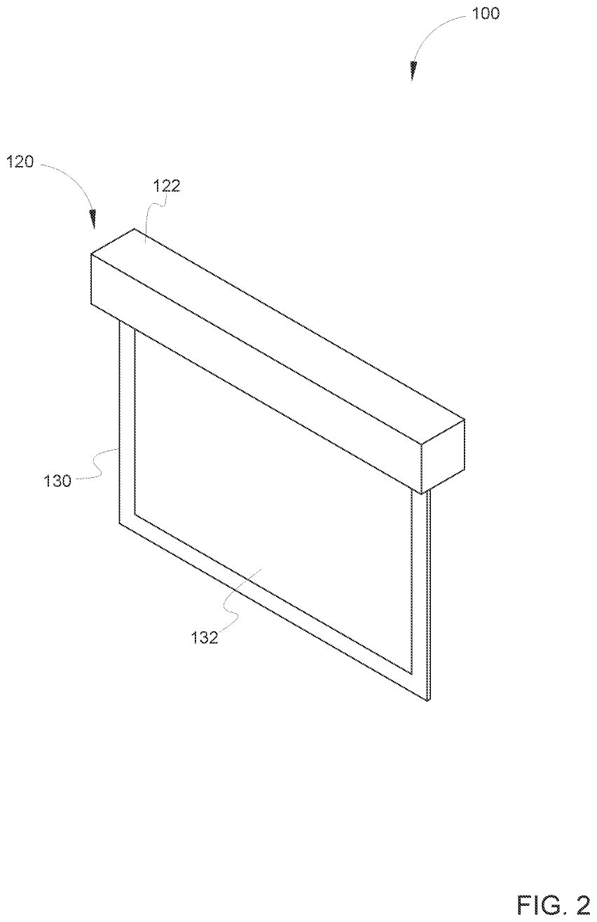

FIG. 2 shows the digital system for virtual settings in interior spaces of FIG. 1, according to an embodiment of the present disclosure. Each window-shade assembly 110 includes frame 120 and shade 130. Shade 130 includes video display screen 132, disposed upon on side of shade 130. Shade 130 is flexible, and accordingly, video display screen 132 must also be flexible. This may be accomplished through the use of OLEDS (organic light-emitting diodes) to construct the video display screen 132. Frame 120 includes header 122, comprising a rigid rectangular hollow housing having sufficient interior space to contain shade 130 when shade 130 is fully retracted and concealed within header 122. Header 122 may be open on an underside, whereby shade 130 can egress and ingress. Header 122 may have the ornamental appearance of an oversized blind header, such that the window-shade assembly 110 assumes an inoffensive and low-profile appearance above the window when shade 130 is fully retracted and concealed from sight. In use, header 122 is to be affixed directly above a window pane, such that when shade 130 is fully deployed, it descends over and covers window 10 (FIG. 1) as viewed from within the interior space.

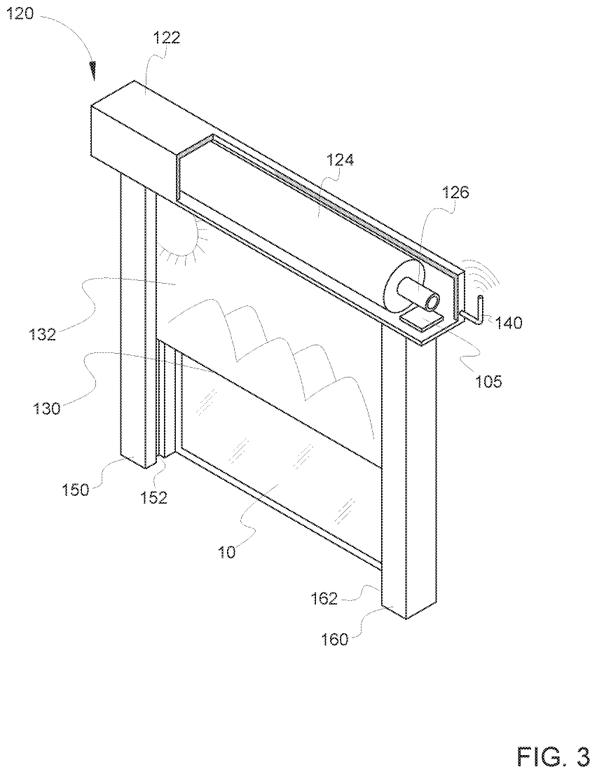

FIG. 3 is a partial cutaway view of the digital system for virtual settings in interior spaces of FIG. 1, according to an embodiment of the present disclosure. As shown, at least one window-shade assembly 110 is able to display the virtual environment. Each of the window-shade assemblies 110 include computer-processor 105, frame 120, shade 130, and wireless transceiver 140. Frame 120 may be able to be mounted proximally to the window. Frame 120 may include header 122, which itself may take the form of a hollow and substantially rectangular body sufficiently large to contain shade 130 about a spindle. In this way, reversible motor 126 may be able to wind the spindle in either direction in order to withdraw or deploy shade 130. When entirely withdrawn, shade 130 may be wound about the spindle.

Shade 130 may be connected to frame 120 and may itself include video display screen 132. As illustrated, video display screen 132 is configured to digitally receive an image or video file and display it. Shade 130 may be able to retract into and be concealed within header 122. Shade-retractor 124 may be mounted within header 122, and may have reversible motor 126. Reversible motor 126 may be in communication with processor 105 and may be able to turn shade-retractor 124 in either direction in order to selectively deploy and retract shade 130. Processor 105 receives a signal and converts the signal to a direct-current signal able to selectively turn reversible motor 126. In some embodiments, tactile controls may be integrated into frame 120 to manipulate processor 105. However, in preferred embodiments, processor is optionally or solely controlled by external wirelessly-connected control sources such as a mobile computing device. Frame 120 further includes wireless transceiver 140 to enact this functional communication. Wireless transceiver 140 may be in digital communication with reversible motor 126 and video display screen 132 via processer 105. Wireless transceiver 140 may communicate via various radio bands, Bluetooth protocol, or other wireless methods.

In the presently illustrated embodiment, frame 120 may also include left frame-rail 150 and right frame-rail 160. Left frame-rail 150 may be affixed to and descend downwardly (downwardly being defined as oriented upon a window when header 122 is mounted above the window) from header 122 along a left-side of the window. Left frame-rail 150 may have left-channel 152 in which shade 130 may rest as it deploys and retracts. Likewise, right frame-rail 160 may be affixed to and descend downwardly from header 122 along the right-side of the window. Right frame-rail 160 may have right-channel 162 in which shade 130 may rest as it deploys and retracts. In this way, left-channel 152 and right-channel 162 face and mirror each other, and shade 130 rides within and is constrained between left-channel 152 and right-channel. Implementation of left frame-rail 150 and right frame-rail 160 prevent shade 130 from fluctuating with drafts or catching on a passerby and adds to the appearance of frame 120 being a traditional window frame, thereby making the virtual setting more believable.

In some alternative embodiments, a blind feature may be implemented. The blinds may also be deployable and retractable, and able to cover shade 130 from the viewpoint of a viewer positioned in the interior space. The blinds may be used to selectively conceal shade 130 just as traditional blinds may be used to conceal a window. Two potential blind embodiments are conceived: firstly, there may be provided blinds consisting or horizontal slats which may descend from and be selectively concealed within header 122. In this first embodiment, cords may be used to suspend and manipulate the horizontal slats, as in traditional window blind systems. Secondly, there may be provided blinds consisting of vertical slats which may be slid out from and be selectively concealed within left frame-rail 150 and right frame-rail 160. In the second embodiment, additional channels may be relieved into left frame-rail 150 and right frame-rail 160 in order to contain the vertical blinds when concealed. An additional track system may be integrated into header 122 as necessary to enact lateral sliding of the vertical slats.

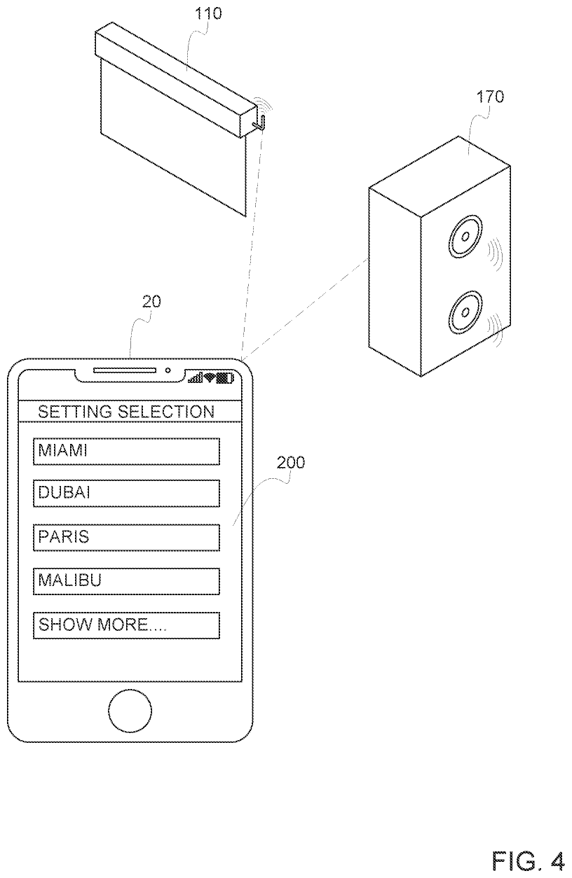

FIG. 4 is a diagram of the interconnectivity of the digital system for virtual settings in interior spaces of FIG. 1, according to an embodiment of the present disclosure. The system 100 may also include at least one speaker 170 able to wirelessly communicate with electronic computing device 20, such that software application 200 may be configurable to play music and alternatively ambience tracks via at least one speaker 170.

Software application 200 may be implementable on electronic computing device 20 (such as a “smart phone”, tablet), laptop, etc.), electronic computing device 20 itself being able to wirelessly communicate with wireless transceiver 140 (FIG. 3), such that software application 200 is able to control input to reversible motor 126 (FIG. 3) and video display screen 132 (FIG. 3) via computer-processor 105. Software application 200 may be able to access a server to obtain the image and/or video data for providing a large variety of views to be displayed upon video display screen 132 (FIG. 3). Software application 200 may include a graphical user interface to ease selection of these views. Additionally, software application 200 may be configured to provide controls for a variety of other parameters.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system comprising:
at least one window-shade assembly able to display a virtual environment, each of the at least one window-shade assembly including
a computer-processor,
a frame able to be mounted proximally to a window, the frame having a header, the header being hollow and having an opening through which the shade may pass,
a shade connected to the frame and comprising a video display screen, the shade being able to retract into and be concealed within the header, and
a shade-retractor mounted within the header having a reversible motor, the shade-retractor being able to rotate within the header on an axis parallel to the header and spool the shade about the shade-retractor and within the header,
a wireless transceiver in digital communication with the reversible motor and the video display screen; and
a software application implementable on an electronic computing device, the electronic computing device itself being able to wirelessly communicate with the wireless transceiver, such that the software application is able to control input to the reversible motor and the video display screen via the computer-processor;
wherein the software application comprises a graphical user interface presenting a user with options for selecting a virtual setting, such that when the user selects the virtual setting, images and alternatively videos corresponding to that virtual setting are display upon the video display screen.

2. The system of claim 1, wherein the frame further comprises
a left frame-rail affixed to and descending downwardly from the header along a left-side of the window, the left frame-rail having a left-channel in which the shade may rest as it deploys and retracts,
a right frame-rail affixed to and descending downwardly from the header along a right-side of the window, the right frame-rail having a right-channel in which the shade may rest as it deploys and retracts,
such that the left-channel and the right-channel face and mirror each other, and the shade rides within and is constrained between the left-channel and right-channel.

3. The system of claim 1, further comprising at least one speaker able to wirelessly communicate with the electronic computing device, such that the software application may be configurable to play music and alternatively ambience tracks via the at least one speaker.

4. The system of claim 1, wherein the opening of the header is rectangular.

5. A system comprising:
at least one window-shade assembly able to display a virtual environment, each of the at least one window-shade assembly including
a computer-processor,
a frame able to be mounted proximally to a window, the frame having a header, the header being hollow and having a rectangular opening through which the shade may pass,
a shade connected to the frame and comprising a video display screen, the shade being able to retract into and be concealed within the header, and
a shade-retractor mounted within the header having a reversible motor, the shade-retractor being able to rotate within the header on an axis parallel to the header and spool the shade about the shade-retractor and within the header,
a wireless transceiver in digital communication with the reversible motor and the video display screen; and
a software application implementable on an electronic computing device, the electronic computing device itself being able to wirelessly communicate with the wireless transceiver, such that the software application is able to control input to the reversible motor and the video display screen via the computer-processor;
at least one speaker able to wirelessly communicate with the electronic computing device, such that the software application may be configurable to play music and alternatively ambience tracks via the at least one speaker;
wherein the software application comprises a graphical user interface presenting a user with options for selecting a virtual setting, such that when the user selects the virtual setting, images and alternatively videos corresponding to that virtual setting are display upon the video display screen; and
wherein the frame further comprises
a left frame-rail affixed to and descending downwardly from the header along a left-side of the window, the left frame-rail having a left-channel in which the shade may rest as it deploys and retracts,
a right frame-rail affixed to and descending downwardly from the header along a right-side of the window, the right frame-rail having a right-channel in which the shade may rest as it deploys and retracts,
such that the left-channel and the right-channel face and mirror each other, and the shade rides within and is constrained between the left-channel and right-channel.
